(19) United States
(12) Patent Application Publication
(10) Pub. No.: US 2023/0120370 A1
(43) Pub. Date: Apr. 20, 2023

(54) Methods and Systems for Tracking User Attention in Conversational Agent Systems

(71) Applicant: 3M INNOVATIVE PROPERTIES COMPANY, St. Paul, MN (US)

(72) Inventor: Detlef Koll, Pittsburgh, PA (US)

(21) Appl. No.: 17/906,197

(22) PCT Filed: Mar. 17, 2021
(86) PCT No.: PCT/IB2021/052240

§ 371 Date: Sep. 13, 2022

Related U.S. Application Data
(60) Provisional application No. 63/008,117, filed on Apr. 10, 2020.

(51) Int. Cl. G10L 15/22; G06F 3/01; G06F 3/16

(52) U.S. Cl. CPC G10L 15/22; G06F 3/013; G06F 3/167; G10L 2015/223

(57) ABSTRACT

A method and system for tracking user attention is disclosed. The method and system receives, by an attention tracking component, a non-audio input from a user. The method and system receives, by a speech processing component, audio input from the user. The method and system determines, by a results processing component, that the attention tracking component received the non-audio input within a first time interval proximate to a second time interval during which the audio input was received. The method and system performs, by the results processing component, at least one actionable command identified within the audio input, based upon the determination that the attention tracking component received the non-audio input within the first time interval and a determination hat the received audio input includes the at least one actionable command.

### BACKGROUND

The disclosure relates to tracking user attention. More particularly, the methods and systems described herein relate to functionality for tracking user attention in connection with conversational agent systems.

Ambient conversational agent products, such as the AMAZON ECHO provided by Amazon.com, Inc., of Seattle, Wash., or the GOOGLE HOME, provided by Google, LLC, of Mountain View, Calif., require explicit indications of a user's intent to interact with the conversational agent in order to initiate an interaction. Commonly, this explicit expression of intent comes in the form of a hot-word or wake-word or phrase preceding the user request (e.g. “Alexa what is the weather for tomorrow”, “OK Google, play music”). The conversational agent listens continuously for wake-words but discards all audio except utterance of the wake word. Once engaged, agents can carry short conversations without requiring wake words for each individual interaction, but once the agent determines that an interaction is complete (e.g. via passage of time, or once a dialog reaches an application defined conclusion) the next interaction again requires a wake word.

While wake-words are an effective and unambiguous way of indicating user intent, they can be unnatural, especially if interactions are frequent. In multi-party dialog settings, e.g. between a physician and patient, user can be reluctant to use wake words. Furthermore, wake-word phrases are chosen to have a minimum length to reduce false alerts (this is why it is “OK Google” and not “Google”), which increases the burden on the user. Thus, it is desirable to remove the need for a wake word or at least to reduce the required minimum length of the wake word.

### BRIEF SUMMARY

In one aspect, a method for tracking user attention in a conversational agent system includes receiving, by an attention tracking component, a non-speech (e.g., non-audio) input from a user. The method includes receiving, by a speech processing component, audio input from the user. The method includes determining, by a results processing component, that the attention tracking component received the non-audio input within first time interval proximate to a second time interval during which the audio input was received. The method includes performing, by the results processing component, at least one actionable command identified within the audio input, based upon the determination that the attention tracking component received the non-audio input within the first time interval and a determination that the received audio input includes the at least one actionable command.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for tracking user attention in a conversational agent system;

FIG. 1B is a block diagram depicting an embodiment of a system for tracking user attention in a conversational agent system;

FIG. 2A is a flow diagram depicting an embodiment of a method for tracking user attention in a conversational agent system;

FIG. 2B is a flow diagram depicting an embodiment of a method for tracking user attention in a conversational agent system;

FIG. 2C is a flow diagram depicting an embodiment of a method for tracking user attention in a conversational agent system; and

FIGS. 3A-3C are block diagrams depicting embodiments of computers useful in connection with the methods and systems described herein.

### DETAILED DESCRIPTION

The methods and systems described herein may provide functionality for tracking user attention in a conversational agent system. Unlike conventional approaches for determining user intent to engage with a conversational agent, in which intent is strongly synchronized with the interaction itself (e.g., by prepending an utterance with a wake word or by pressing a “start recording” button on a microphone followed by an utterance), the methods and systems described herein provide functionality for processing audio input separately from a component tracking a user's intent to interact. The expression of user intent is not necessarily strictly time-synchronized as it can happen before (but in temporal proximity to the utterance), during, or after (again in temporal proximity) of a user utterance.

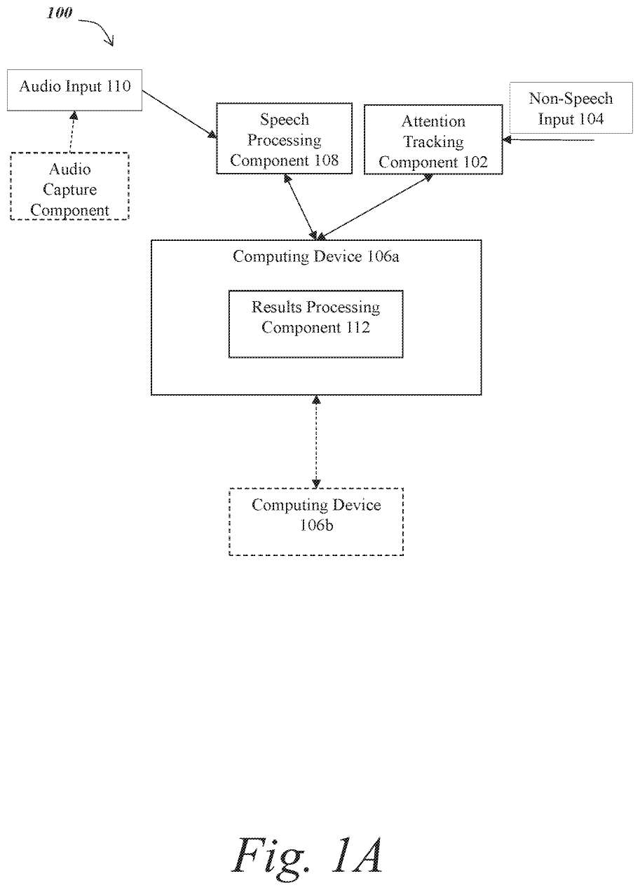

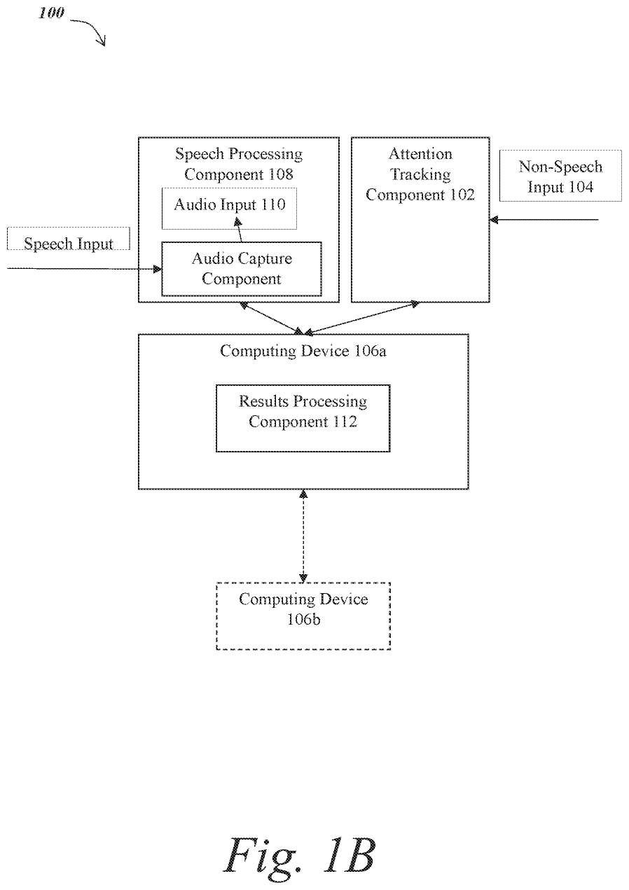

Referring now to FIG. 1A, a block diagram depicts one embodiment of a system for tracking user attention in a conversational agent system. In brief overview, the system 100 includes a computing device 106a, an attention tracking component 102, a speech processing component 108, and a results processing component 112. The system may optionally include an audio capture component. The system 100 may optionally include a computing device 106b.

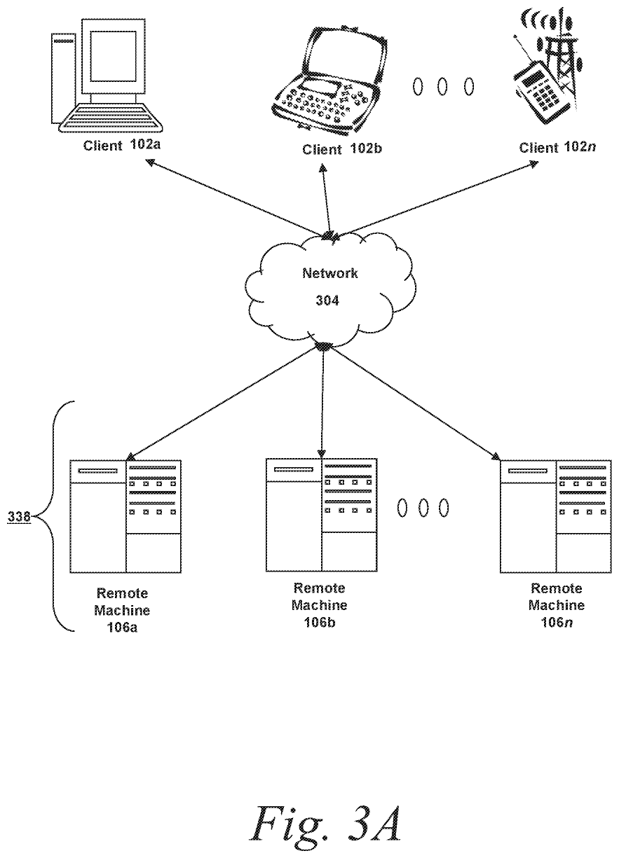

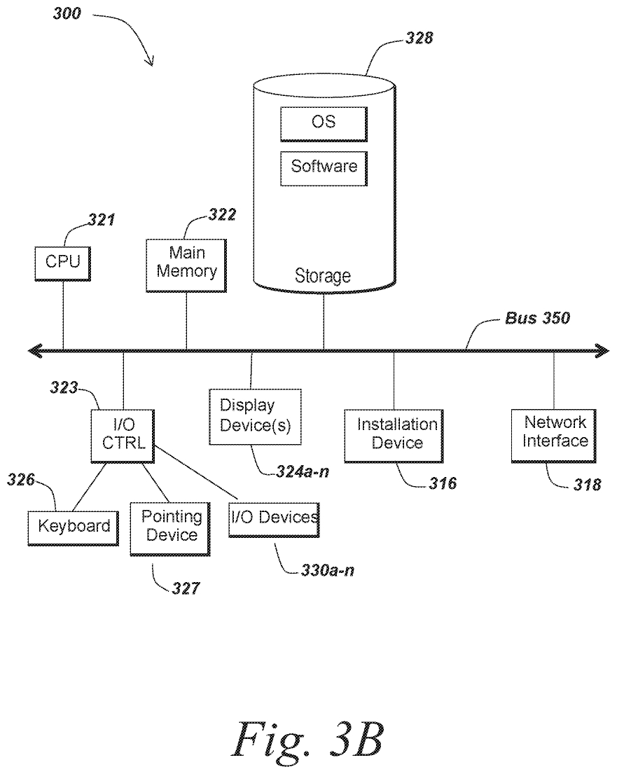

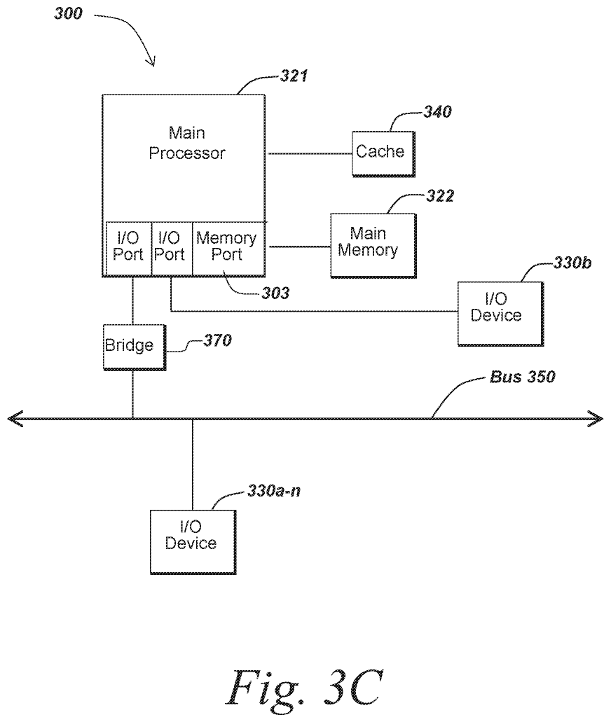

The computing device 106a (referred to generally as a computing device 106) may be a modified type or form of computing device (as described in greater detail below in connection with FIGS. 3A-C) that has been modified to execute instructions for providing the functionality described herein, resulting in a new type of computing device that provides a technical solution to a problem rooted in computer network technology.

The attention tracking component 102 may be provided as a hardware component. The attention tracking component 102 may be provided as a software component. The attention tracking component 102 may include functionality for receiving non-speech (e.g., non-audio) input 104 from a user. The computing device 106a may execute the attention tracking component 102. Alternatively, a separate computing device 106c (not shown) may execute the attention tracking component 102. The attention tracking component 102 may include a gaze tracker. The attention tracking component 102 may include functionality for identifying when the user gazes at a visual focal point. The attention tracking component 102 may include a button for receiving non-speech (e.g., non-audio) input. The attention tracking component 102 may include a foot-pedal for receiving non-speech (e.g., non-audio) input. Any reference to “non-speech input” herein includes, for example, non-audio input, e.g., input that includes or consists of non-audio data.

The speech processing component 108 may be provided as a hardware component. The speech processing component 108 may be provided as a software component. As shown in FIG. 1A, the speech processing component 108 may receive audio input 110 generated by another device and process the received audio input 110. For example, the speech processing component 108 may be in communication with an audio capture component (shown in shadow in FIG. 1A). The speech processing component 108 may include a signal processing module. The speech processing component 108 may include or be in communication with one or more databases (not shown) for storing received audio input. The computing device 106a may execute the speech processing component 108. Alternatively, a separate computing device 106d (not shown) may execute the speech processing component 108.

Referring ahead to FIG. 1B, a block diagram depicts an embodiment of the system 100 in which the speech processing component 108 includes an audio capture component. The speech processing component 108 may capture speech and generate audio input 110 based upon the captured speech.

The audio capture component — whether part of the speech processing component 108 or a separate component—captures speech, producing audio input 110, and provides the audio input 110 to the speech processing component 108. The audio capture component may, for example, be one or more microphones, such as a microphone located in the same room as a number of speakers, or distinct microphones spoken into by distinct speakers. In the case of multiple audio capture devices, the audio output may include multiple audio outputs, which are shown as the single audio input 110 in FIGS. 1A-1B for ease of illustration.

Referring back to FIG. 1A, the results processing component 112 may be provided as a hardware component. The results processing component 112 may be provided as a software component. The computing device 106a may execute the results processing component 112. The results processing component 112 may be in communication with the speech processing component 108. The results processing component 112 may be in communication with the attention tracking component 102. The results processing component 112 may include functionality for forwarding an actionable command to an application for execution, such as an application executed by the computing device 106a or by a second computing device 106b.

Although, for ease of discussion, the attention tracking component 102, the speech processing component 108, the results processing component 112, and the audio capture component are described in FIG. 1 as separate modules, it should be understood that this does not restrict the architecture to a particular implementation. For instance, these components may be encompassed by a single circuit or software function or, alternatively, distributed across a plurality of computing devices.

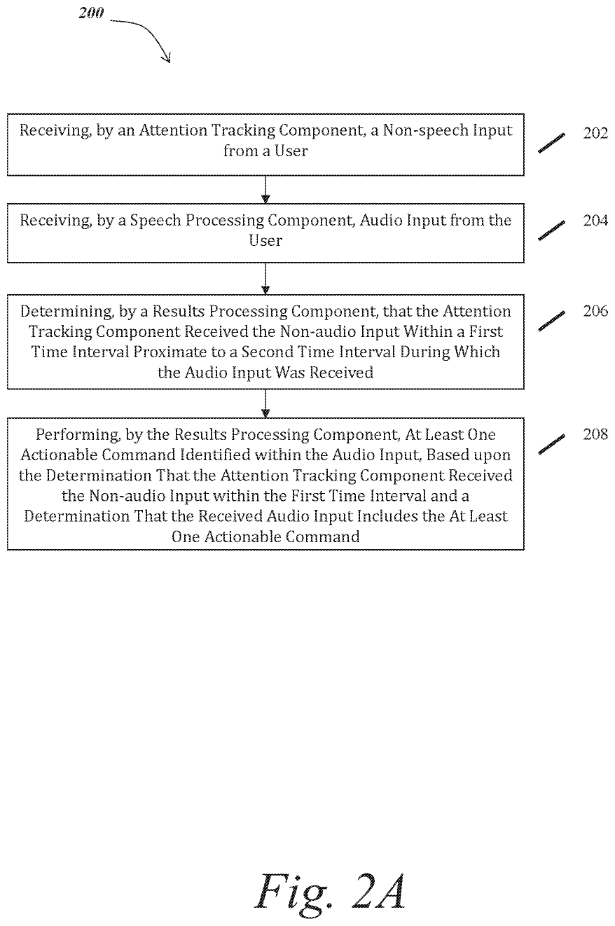

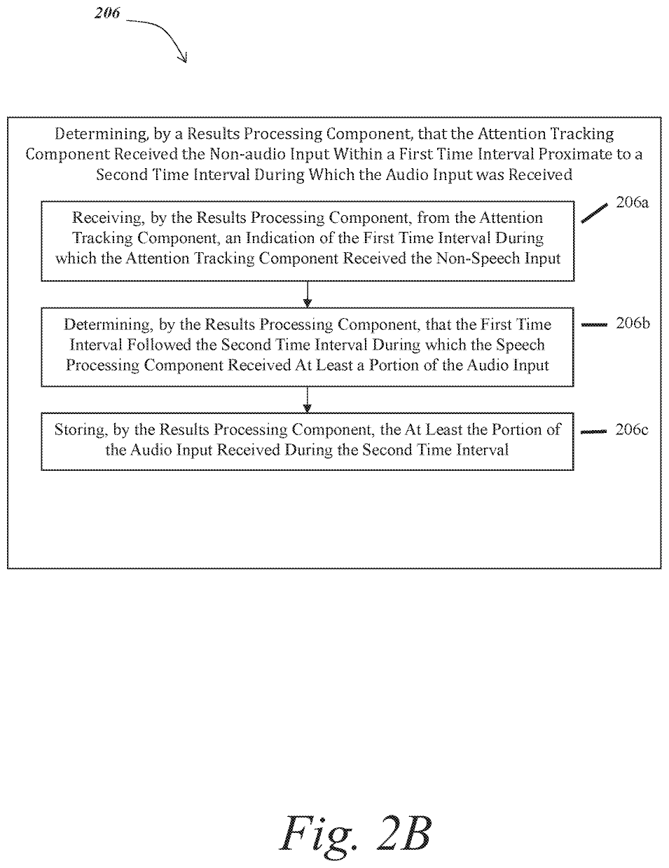

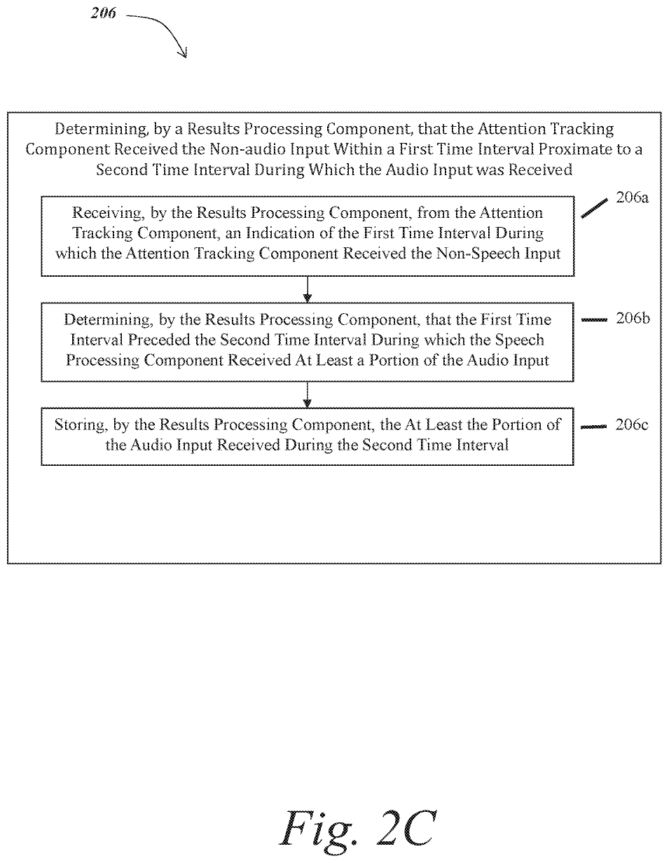

Referring now to FIG. 2A, in brief overview, a block diagram depicts one embodiment of a method 200 for tracking user attention in a conversational agent system. The method 200 includes receiving, by an attention tracking component, a non-speech input from a user (202). The method 200 includes receiving, by a speech processing component, audio input from the user (204). The method 200 includes determining, by a results processing component, that the attention tracking component received the non-audio input within a first time interval proximate to a second time period during which the audio input was received (206). The method 200 includes performing, by the results processing component, at least one actionable command, based upon the determination that the attention tracking component received the non-audio input within the first time interval and a determination that the received audio input includes the at least one actionable command (208).

Referring now to FIG. 2A in connection with FIGS. 1A-1B, and in greater detail, the method 200 includes receiving, by an attention tracking component, a non-speech input from a user (202). The attention tracking component 102 may receive the non-speech input from the user. The attention tracking component 102 may determine that the user gazed at a visual focal point in physical proximity to the user. For example, the attention tracking component 102 may include a visual focal point installed in a room in which the user will be speaking and the attention tracking component 102 may determine whether a user looks at the visual focal point. The visual focal point may be any object in the room, including, for example and without limitation, a picture on a wall, a mirror, a smart speaker, or an avatar for the conversational agent. The avatar may or may not be integrated with the camera or other device that detects the user's gaze. For example, a camera may detect that the user is gazing at an avatar on the other side of the room. Gazing at the object and having that gaze detected would obviate the need for a wake-word in some cases. In other cases, gazing at the object and having that gaze detected would allow for the use of a shorter wake word than would be required by a conventional conversational agent.

The attention tracking component 102 may receive physical input to a user interface element of the attention tracking component 102. The attention tracking component 102 may include or be in communication with a button or foot-pedal or similar mechanical device. However, unlike a conventional start-recording button on a microphone, a conventional keyboard, or a conventional user interface, a button indicating an intention to interact does not have to have any direct function, other than to transmit, to the attention tracking component 102, an indication that the button was pressed. That is, the button does not need to send a start signal to the system; the button need only indicate to the system that the button was pressed, such as by the button making a sound that is detected to determine that the button was pressed. In some embodiments, the button may transmit a time stamp of a time at which a user pressed the button. A button press in temporal proximity to an actionable command may be interpreted as a user intention to execute the actionable command.

The method 200 includes receiving, by a speech processing component, audio input from the user (204). As indicated above, the audio capture component, whether integrated into the speech processing component 108 or a separate component, may capture speech, generate audio input 110, and provide the audio input 110 to the speech processing component 108.

The method 200 may include determining, by the speech processing component, that the received audio input includes at least one actionable command. In some embodiments, the speech processing component 108 may receive all captured audio input but determine whether or not to process (e.g., apply a speech recognition process to the audio input) any portion of the speech in the audio input based on an instruction from the results processing component; by way of example, and without limitation, the results processing component 112 may indicate to the speech processing component 108 that the attention tracking component 102 has received an indication of intent to interact from the user and the results processing component 112 may direct the speech processing component 108 to process a portion of the audio input 110. In other embodiments, the speech processing component 108 processes a subset of the received audio input to determine whether the subset of the received audio input includes the at least one actionable command but the speech processing component 108 does not process (e.g., recognize) the entirety of the received audio input. For example, the speech processing component 108 may include functionality for processing a small portion of the audio input to determine whether it includes any wake words; such a speech processing component 108 would be a more “lightweight” and/or lower cost component without needing to provide functionality for recognizing a wide variety of speech while being able to reduce the length of a wake word needed in the speech. In further embodiments, the speech processing component 108 processes all received audio input but does not take any action on that processed audio input (e.g., executing an actionable command or forwarding an identification of the actionable command to a computer process for execution) until receiving an instruction to do so from the results processing component 112. In such an embodiment, the speech processing component 108 may provide more extensive functionality for recognizing a more comprehensive range of speech than a lightweight/lower cost speech processing component. The speech processing component 108, therefore, may determine that the received audio input includes at least one actionable command by processing a subset of the received audio input or by processing all received audio input. The speech processing component 108 may determine that the received audio input includes a keyword.

The speech processing component 108 may receive the audio input and make a determination regarding whether the audio input contains an actionable command separately from the attention tracking component 102 receiving the non-audio input. The speech processing component 108 may receive the audio input before the attention tracking component 102 receives the non-audio input 104. The speech processing component 108 may receive the audio input after the attention tracking component 102 receives the non-audio input. The speech processing component 108 may receive the audio input at substantially the same time as the attention tracking component 102 receives the non-audio input. As an example, the attention tracking component 102 may receive non-audio input, such as an indication that the user gazed at a visual focal point, at a time before, during, or after the user made a statement including at least one actionable command, such as an instruction to generate and transmit to a pharmacy a prescription of a particular medicine at a particular dosage for a particular patient.

The method 200 includes determining, by a results processing component, that the attention tracking component received the non-audio input within a first time interval proximate to a second time interval during which the audio input was received (208). The results processing component 112 may determine whether the non-audio input was received within the first time interval proximate to the receiving of the audio input to determine whether or not the system should conclude that the user intended to interact with the system to have at least one actionable command executed. The results processing component 112 may be configured to include a specific time period defined as a proximate amount of time within which to receive the audio input and non-audio input. The results processing component 112 may be configured to include a range of times based upon different conditions within which the audio input and non-audio input may be considered to have been received proximate to one another.

The speech processing component 108 may transmit an indication of a time at which the speech processing component 108 received the audio input including the at least one actionable command. The speech processing component 108 may transmit an indication of a time interval (e.g., the second time interval) during which the speech processing component 108 received the audio input including the at least one actionable command. The attention tracking component 102 may transmit, to the results processing component 112, an indication of receipt of the non-speech input. The attention tracking component 102 may transmit, to the results processing component 112, an indication of a first time at which the attention tracking component 102 received the non-speech input. The attention tracking component 102 may transmit, to the results processing component 112, an indication of a first time interval during which the attention tracking component 102 received the non-speech input. For example, the attention tracking component 102 may generate a time stamp of a time at which user interacted with a physical device or a visual focal point (e.g., based upon determining that the user gazed at the visual focal point or that a button emitted a signal indicating the user pressed the button) or the attention tracking component 102 may receive a time stamp of a time at which user interacted with the physical device (e.g., by receiving, from a button on a physical device, a time stamp of a time at which a user pressed the button); the attention tracking component 102 may then transmit the indication of the first time (e.g., the time stamp) to the results processing component 112. The attention tracking component 102 may transmit, to the results processing component 112, an audio signal indicating receipt of the non-speech input. The attention tracking component 102 may transmit, to the speech processing component 108, an audio signal indicating receipt of the non-speech input.

Referring ahead to FIG. 2B, a flow diagram depicts one embodiment of the method 200 expanding upon FIG. 2A, 206, in which the results processing component determines that the attention tracking component received the non-audio input within a first time interval proximate to a second time interval during which the audio input was received. As depicted in FIG. 2B, the method 200 may include receiving, by the results processing component 112, from the attention tracking component 102, an indication of a first time interval during which the attention tracking component 102 received the non-speech input 104 (206a). The method 200 may include determining, by the results processing component, that the first time interval followed a second time interval during which the speech processing component received at least a portion of the audio input (206b). The method 200 may include storing, by the results processing component, the at least the portion of the audio input received during the second time interval (206c). Therefore, the method 200 may include storing speech that occurs during a time before the attention tracking component 102 determines that a user has an intention to interact with the system and that speech may be processed and the system may direct the execution of actionable commands within that speech even though the user does not indicate an intention to interact with the system until after the commands were spoken.

Referring ahead to FIG. 2C, a flow diagram depicts one embodiment of the method 200 expanding upon FIG. 2A, 206, in which the results processing component determines that the attention tracking component received the non-audio input within a first time interval proximate to a second time interval during which the audio input was received. As depicted in FIG. 2C, the method 200 may include receiving, by the results processing component 112, from the attention tracking component 102, an indication of a first time interval during which the attention tracking component 102 received the non-speech input 104 (206a). The method 200 may include determining, by the results processing component, that the first time interval preceded the second time interval (206b). The method 200 may include storing, by the results processing component, the at least the portion of the audio input received during the second time interval (206c). Therefore, the method 200 may include storing speech that occurs during a time after the attention tracking component 102 determines that a user has an intention to interact with the system and that speech may be processed and the system may execute or direct the execution of actionable commands within that speech.

Referring back to FIG. 2A, the method 200 includes performing, by the results processing component, at least one actionable command identified within the audio input, based upon the determination that the attention tracking component received the non-audio input within the first time interval and a determination that the received audio input includes the at least one actionable command (208). The results processing component 112 may perform the at least one actionable command directly. The results processing component 112 may perform the at least one actionable command indirectly; for example, the results processing component 112 may direct the execution of the at least one actionable command by another component, such as an application running on the same or a different computing device. In an embodiment in which the attention tracking component 102 transmits, to the results processing component 112, an indication of a first time at which the attention tracking component 102 received the non-speech input 104, the results processing component 112 may perform, or cause the performance of, the at least one actionable command included in audio input received at a time that preceded the time at which the intention to interact was received by the attention tracking component 102. Similarly, in an embodiment in which the attention tracking component 102 transmits, to the results processing component 112, an indication of a first time at which the attention tracking component 102 received the non-speech input 104 (or of a first time interval during which the attention tracking component 102 received the non-speech input 104), the results processing component 112 may perform, or cause the performance of, the at least one actionable command included in audio input received at a time subsequent to the time at which the intention to interact was received by the attention tracking component 102.

The speech processing component 108 may store audio input in a database (e.g., for subsequent processing). The speech processing component 108 may receive all captured audio but determine whether or not to store the audio input based on an instruction from the results processing component.

In this way, the speech processing component 108 (alone or in conjunction with execution of an audio capture component) may capture some or all incoming speech, independent of whether a user expressed an intention to interact with the system, but the system would only execute an action based upon the user's speech if there is an actionable command and an expression of intent from the attention tracking component 102. The at least one actionable command may include a first command to execute a second command within a computer application. The at least one actionable command may include a command to insert data into a medical record. The at least one actionable command may include a command to generate and transmit a prescription (e.g., to a pharmacy). The at least one actionable command may include a command to provide at least one result from a speech recognition process to a computing device. The at least one actionable command may include a command to provide at least one result from a speech recognition process to a computer program.

In some embodiments, the system 100 includes non-transitory, computer-readable medium comprising computer program instructions tangibly stored on the non-transitory computer-readable medium, wherein the instructions are executable by at least one processor to perform a method for tracking user attention in a conversational agent system, the method includes receiving, by an attention tracking component, a non-speech input from a user; receiving, by a speech processing component, audio input from the user; determining, by a results processing component, that the attention tracking component received the non-audio input within a first time interval proximate to a second time interval during which the audio input was received; and performing, by the results processing component, at least one actionable command, based upon the determination that the attention tracking component received the non-audio input within the first time interval and a determination that the received audio input includes the at least one actionable command, wherein the instructions are executable by at least one processor to perform each of the steps described above in connection with FIGS. 2A-2C.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 304.

Although FIG. 3A shows a network 304 between the clients 102 and the remote machines 106, the clients 102 and the remote machines 106 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the clients 102 and the remote machines 106. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif..

In some embodiments, the system may include multiple, logically-grouped remote machines 106. In one of these embodiments, the logical group of remote machines may be referred to as a server farm 338. In another of these embodiments, the server farm 338 may be administered as a single entity.

FIGS. 3B and 3C depict block diagrams of a computing device 100 useful for practicing an embodiment of the client 102 or a remote machine 106. As shown in FIGS. 3B and 3C, each computing device 100 includes a central processing unit 321, and a main memory unit 322. As shown in FIG. 3B, a computing device 100 may include a storage device 328, an installation device 316, a network interface 318, an I/O controller 323, display devices 324a-n, a keyboard 326, a pointing device 327, such as a mouse, and one or more other I/O devices 330a-n. The storage device 128 may include, without limitation, an operating system and software. As shown in FIG. 1C, each computing device 100 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 322 may be one or more memory chips capable of storing data and allowing any storage location to be directly accessed by the microprocessor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 100 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computer 100 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 100, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation medium 316 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 3B, the computing device 100 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 100 may provide functionality for installing software over a network 304. The computing device 100 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 100 may include a network interface 318 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In further embodiments, an I/O device 330 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 3B and 3C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

Having described certain embodiments of methods and systems for tracking user attention in a conversational agent system, it will be apparent to one of skill in the art that other embodiments incorporating the concepts of the disclosure may be used.

1. A method for tracking user attention in a conversational agent system, the method comprising:
receiving, by an attention tracking component, a non-audio input from a user;
receiving, by a speech processing component, audio input from the user;
determining, by a results processing component, that the attention tracking component received the non-audio input within a first time interval proximate to a second time interval during which the audio input was received; and
performing, by the results processing component, at least one actionable command identified within the audio input, based upon the determination that the attention tracking component received the non-audio input within the first time interval and a determination that the received audio input includes the at least one actionable command.

2. The method of claim 1, wherein receiving the non-speech input comprises determining that the user gazed at a visual focal point in physical proximity to the user.

3. The method of claim 1, wherein receiving, by the attention tracking component, the non-speech input comprises receiving physical input to a user interface element of the attention tracking component.

4. The method of claim 1 further comprising transmitting, by the attention tracking component, to the results processing component, an indication of the first time interval during which the attention tracking component received the non-audio input.

5. The method of claim 1, wherein determining, by the results processing component, that the attention tracking component received the non-audio input within the first time interval proximate to the second time interval further comprises:
determining, by the results processing component, that the first time interval followed the second time interval during which the speech processing component received at least a portion of the audio input; and
storing, by the results processing component, the at least the portion of the audio input received during the second time interval.

6. The method of claim 4, wherein determining, by the results processing component, that the attention tracking component received the non-audio input within the first time interval proximate to the second time interval further comprises:
determining, by the results processing component, that the first time interval preceded the second time interval during which the speech processing component received at least a portion of the audio input; and
storing, by the speech processing component, the at least the portion of the audio input received during the second time interval.

7. The method of claim 4, wherein performing the at least one actionable command further comprises performing an actionable command included in audio input received at a time that preceded the first time.

8. The method of claim 4, wherein performing the at least one actionable command further comprises performing an actionable command included in audio input received at a time subsequent to the first time.

9. The method of claim 1 further comprising determining, by the speech processing component, that the received audio input includes at least one actionable command.

10. The method of claim 1 further comprising transmitting, by the attention tracking component, to the speech processing component, an audio signal indicating receipt of the non-audio input.

11. The method of claim 1 further comprising transmitting, by the attention tracking component, to the speech processing component, an indication of receipt of the non-audio input.

12. The method of claim 1 further comprising transmitting, by the attention tracking component, to the results processing component, an indication of receipt of the non-speech input.

13. The method of claim 1 further comprising storing, by the speech processing component, the received audio input for subsequent processing.

14. The method of claim 1, wherein determining, by the speech processing component, that the received audio input includes at least one actionable command further comprises processing a subset of the received audio input.

15. The method of claim 1, wherein determining, by the speech processing component, that the received audio input includes at least one actionable command further comprises processing all received audio input.

16. The method of claim 1 further comprises determining, by the speech processing component, that the received audio input includes a keyword.

17. The method of claim 1 wherein receiving, by the speech processing component, the received audio input comprises receiving the audio input before receiving, by the attention tracking component, the non-audio input.

18. A system for tracking user attention comprising:
an attention tracking component receiving non-audio input from a user;
a speech processing component receiving audio input from the user; and
a results processing component (i) determining that the attention tracking component received the non-audio input within a first time interval proximate to a second time interval during which the audio input was received, and (ii) performing at least one actionable command identified within the audio input, based on the determination that the attention tracking component received the non-audio input within the first time interval and a determination that the received audio input includes the at least one actionable command.

19. The system of claim 18, wherein the attention tracking component comprises a gaze tracker.

20. The system of claim 18, wherein the attention tracking component comprises functionality for identifying when the user gazes at a visual focal point.

21. The system of claim 18, wherein the attention tracking component comprises a button for receiving non-audio input.

22. The system of claim 18, wherein the attention tracking component comprises a foot-pedal for receiving non-audio input.

23. A non-transitory, computer-readable medium encoded with computer-executable instructions that, when executed on a computing device, cause the computing device to carry out a method for tracking user attention in a conversational agent system, the method comprising:
receiving, by an attention tracking component, a non-audio input from a user;
receiving, by a speech processing component, audio input from the user;
determining, by a results processing component, that the attention tracking component received the non-audio input within a first time interval proximate to a second time interval during which the audio input was received; and
performing, by a results processing component, at least one actionable command identified within the audio input, based on the determination that the attention tracking component received the non-audio input within the first time interval and a determination that the received audio input includes the at least one actionable command.
